(19) United States
(12) Patent Application Publication
(10) Pub. No.: US 2022/0219862 A1
(43) Pub. Date: Jul. 14, 2022

(54) Product Packaging and Associated System and Method for Authenticating a Product

(71) Applicant: WestRock Shared Services, LLC, Atlanta, GA (US)

(72) Inventor: John P. DWYER, Glen Alen, VA (US)

(21) Appl. No.: 17/506,357

(22) Filed: Oct. 20, 2021

Related U.S. Application Data
(60) Provisional application No. 63/192,290, filed on May 24, 2021.
(60) Provisional application No. 63/093,823, filed on Oct. 20, 2020.

(51) Int. Cl. B65D 25/20; B65D 55/06

(52) U.S. Cl. CPC B65D 25/205; B65D 55/06

(57) ABSTRACT

Product packaging includes a packaging container configured to contain product. The packaging also includes a first tag disposed on the packaging container and encoded with a first one of a plurality of package attributes and a second code disposed on the packaging container and encoded with a second one of the plurality of package attributes. The first tag and the second tag are linked to each other to determine authenticity of the product.

### FIELD

The present disclosure relates generally to product packaging and shipping and, more particularly, to packaging, systems, and methods for authenticating product through a supply chain.

### BACKGROUND

In the field of product packaging and shipping, product may be packaged in a container to ensure handling requirements are met or to prevent incidental damage during shipment. Tracking systems may be used to ensure accuracy and integrity of deliveries from one location to another. Such tracking systems often employ the use of codes attached to the packaging. Such codes may also be used to verify that the product was packaged by and is an authentic product from the original producer. However, such codes can be easily duplicated, replaced with fraudulent codes or be removed or damaged, thus rendering them ineffective for counterfeit detection. Another problem is that authentic packaging may be filled with counterfeit products, thus again defeating the conventional system.

For shipping and product protection considerations, it is desirable to ensure that packaging containers have suitable strength for holding and transporting the product. For cost and environmental considerations, it is also desirable for packaging containers be formed from as little material as possible and cause as little wastage in the materials as possible. For cost and process considerations, it is also desirable for packaging containers to be formed through as simple a set of operations as possible to aid in automation of the container formation and loading process. For shipping and anti-counterfeiting considerations, it is also desirable for product to be authenticated through the supply chain without opening the packaging container.

Accordingly, those skilled in the art continue with research and development efforts in the field of product packaging and authentication.

### SUMMARY

Disclosed are product packaging and associated systems and methods for authenticating a product. The following is a non-exhaustive list of examples, which may or may not be claimed, of the subject matter according to the present disclosure.

In an example, the disclosed product packaging includes a packaging container configured to contain product. The packaging also includes a first tag disposed on the packaging container and encoded with a first one of a plurality of package attributes and a second code disposed on the packaging container and encoded with a second one of the plurality of package attributes. The first tag and the second tag are linked to each other to determine authenticity of the product.

In an example, the disclosed method for authenticating product includes steps of: (1) using a first tag, applied to a packaging container containing the product, as a first authentication factor, the first tag being encoded with a first one of a plurality of package attributes; (2) determining a first authenticity result for the product based on validation of the first tag; (3) using a second tag, applied to a sealing member affixed over a closure feature of the product packaging, as a second authentication factor, the second tag being encoded with a second one of a plurality of package attributes; and (4) determining a second authenticity result for the product based on a valid association of the second tag with the first tag.

In an example, the disclosed system for product authentication includes a packaging container configured to contain product. The system also includes a loading apparatus configured to load the product into the packaging container. The system further includes a sealing apparatus configured to seal the packaging container in a closed state. The system additionally includes a tagging apparatus configured to apply a first tag, encoded with a first one of a plurality of package attributes, and a second tag, encoded with a second one of a plurality of package attributes, to the packaging container. The system also includes a computing device configured to record the first tag and the second tag and to link the first tag and the second tag together.

In an example, the disclosed method for packaging product includes steps of: (1) loading the product in a packaging container; (2) sealing the packaging container in a closed state; (3) affixing a first tag to the packaging container, the first tag being encoded with a first one of a plurality of package attributes; (4) affixing a second tag to the packaging container, the second tag (108) being encoded with a second one of the plurality of attributes; (5) recording the first tag and the second tag; and (6) linking the first tag and the second tag together.

Other examples of the disclosed packaging containers, system and methods will become apparent from the following detailed description, the accompanying drawings, and the appended claims.

### BRIEF DESCRIPTION OF THE DRAWINGS

FIG. 1 is a schematic illustration of an example of the disclosed product packaging;

FIG. 2 is a schematic block diagram of an example of an operating environment in which product is authenticated using the disclosed product packaging;

FIG. 3 is a flow diagram of an example of the disclosed method for authenticating product;

FIG. 4 is a schematic illustration of an example the disclosed system for product authentication; and

FIG. 5 is a flow diagram of an example of the disclosed method for product packaging.

### DETAILED DESCRIPTION

The following detailed description refers to the accompanying drawings, which illustrate specific examples of the disclosed carton and blank described by the present disclosure. It will be understood that the disclosed examples are merely exemplary embodiments of the way in which certain aspects of the invention can be implemented and do not represent an exhaustive list of all of the ways the invention may be embodied. Other examples having different structures and operations do not depart from the scope of the present disclosure. Like reference numerals may refer to the same feature, element, or component in the different drawings. The figures are not necessarily to scale and some features may be exaggerated or minimized to show details of particular components. Throughout the present disclosure, any one of a plurality of items may be referred to individually as the item and a plurality of items may be referred to collectively as the items. Moreover, as used herein, a feature, element, component, or step preceded with the word “a” or “an” should be understood as not excluding a plurality of features, elements, components or steps, unless such exclusion is explicitly recited.

Illustrative, non-exhaustive examples, which may be, but are not necessarily, claimed, of the subject matter according the present disclosure are provided below. Reference herein to “example” means that one or more feature, structure, element, component, characteristic, and/or operational step described in connection with the example is included in at least one aspect, embodiment, and/or implementation of the subject matter according to the present disclosure. Thus, the phrases “an example,” “another example,” “one or more examples,” and similar language throughout the present disclosure may, but do not necessarily, refer to the same example. Further, the subject matter characterizing any one example may, but does not necessarily, include the subject matter characterizing any other example. Moreover, the subject matter characterizing any one example may be, but is not necessarily, combined with the subject matter characterizing any other example.

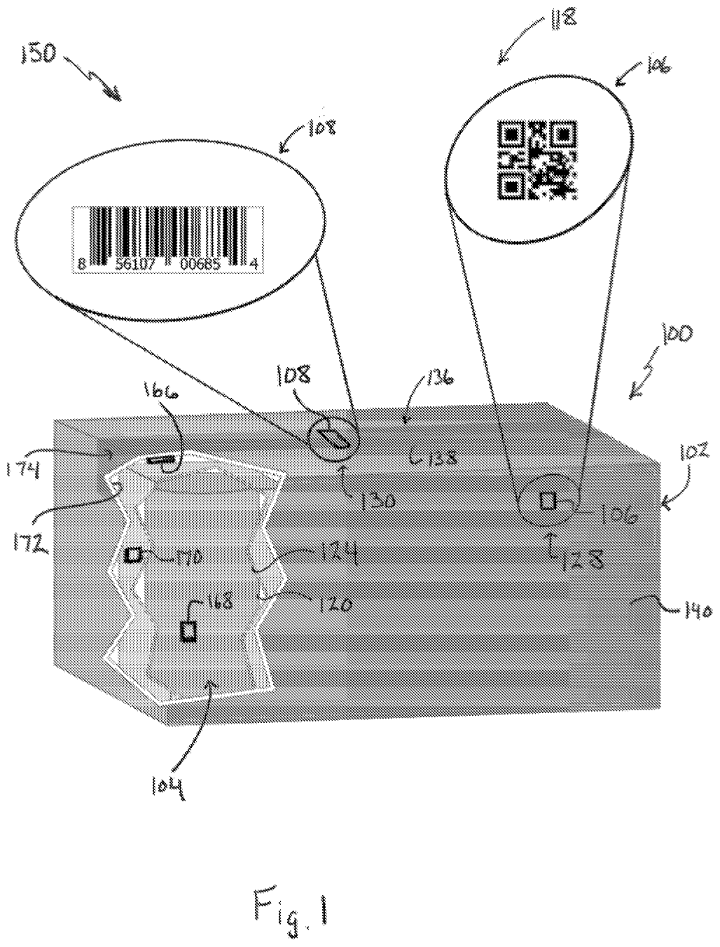

Referring to FIGS. 1-5, by way of examples, the present disclosure is generally directed to packaging and authentication of product. More specifically, the present disclosure is directed to product packaging, packaging systems, packaging methods related to monitoring compliance with a specified workflow related to delivery of packages and authentication of product contained by the packages.

Examples of the packaging, systems and methods disclosed herein may be implemented in a business-to-business (B2B) workflow or a business-to-consumer (B2C) workflow. As an illustrative example, a workflow may define a set of events or activities related to establishment of a package for delivery by a supplier or vendor, one or more modes of transit and intermediaries, and culminating with the delivery of the package at a specified recipient location. The workflow may further define a set of events or activities related to collection of information utilized to determine whether product contained by the package is authentic. Implementation of the workflow may utilize a combination of mobile computing devices, physical devices, and data processing applications.

Examples the packaging, systems and methods disclosed herein provide for multi-layered product authentication by employing unique scannable or readable tags affixed to product packaging and a central server with a database to validate the authenticity of the packaging and the product contained within the packaging based on an association between the tags. Each one of the tags includes a code or symbol having encoded information that represents at least one verifiable attribute or characteristic associated with the packaging and/or the product. To verify authenticity of a product contained by packaging bearing such tags, a user may use a computing device to scan or read the information encoded within a first one of the tags. The central server determines, based on database records, whether the first one of the tags is genuine and is associated with the packaging and, thus, provides a first level, or layer, of authentication. If so, a second level, or layer, of authentication is opened, and the user may use a computing device to then scan or read the information encoded within a second one of the tags. The central server determines, based on database records, whether the second one of the tags is genuine, is associated with the packaging and is associated with the first one of the tags. If so, an indication that the packaging is authentic is provided. If not, an alert is provided. Additional levels, or layers, of authentication may be provided using additional tags. Accordingly, implementations of the packaging, systems and methods disclosed herein advantageously facilitate reliable product authentication without the need to open product packaging or otherwise disrupt the supply chain.

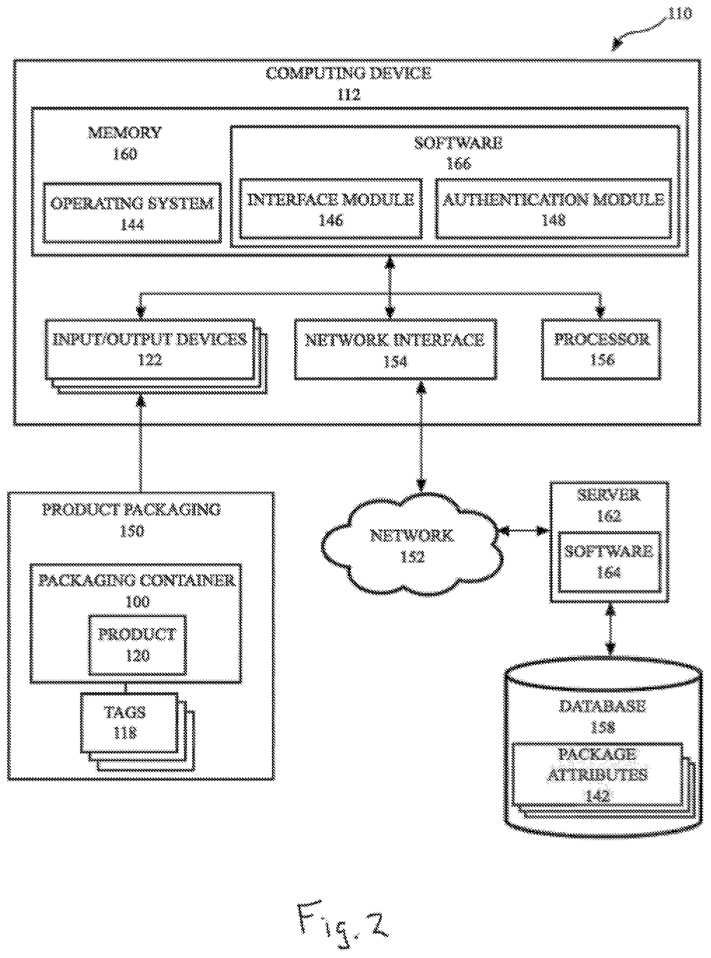

Referring to FIG. 1, which schematically illustrates an example of product packaging 150. The product packaging 150 includes a packaging container 100 configured to contain product 120. The product packaging 150 also includes a plurality of tags 118 used for authentication. Each one of the plurality of tags 118 is encoded with at least one of a plurality of package attributes 142 (FIG. 2). The plurality of tags 118 are linked to each other to determine the authenticity of the product 120. In an example, the plurality of tags 118 is read in a successive manner such that a valid association, or link, between the tags 118 indicates or verifies the authenticity of the product 120.

In one or more examples, the tags 118 may be sequential, random, or generated in accordance with an algorithm or other routine. In one or more examples, the tags 118 may share a common identifier (e.g., a common prefix) that indicates that the tags 118 are associated with or are linked to each other.

The packaging container 100 is configured to be loaded with the product 120 and to be sealed in a closed state. The packaging container 100 is used to securely hold the product 120 for shipping. The packaging container 100 may take the form of any one of various types of containers suitable for packaging the product 120, such as a box, a carton, a case, a wrap, or other receptacle. The packaging container 100 is configured to contain any number of (e.g., one or more) products 120. The packaging container 100 may have any size and/or shape suitable for the product 120 or number of products 120. The product 120 may include raw materials, intermediate goods, goods, package modules of goods, and the like.

Generally, at least two of the tags 118 are disposed about an exterior of the packaging container 100 such that they are accessible (e.g., able to be read) with the packaging container 100 in the closed state (e.g., without the need to open the packaging container 100). While not explicitly illustrated in FIG. 1, in other examples, the product packaging 150 may include more than two tags 118 disposed on the exterior of the packaging container 100. At least one of the tags 118 may be disposed on an interior of (e.g., enclosed within) the packaging container 100 such that they are only accessible (e.g., able to the read) with the packaging container 100 in an open state (e.g., after opening the packaging container 100).

The packaging container 100 includes a plurality of walls 102 that define an enclosed internal volume 104 within which the product 120 is contained. In one or more examples, the packaging container 100 includes two horizontal walls (e.g., a bottom wall and a top wall) and four vertical walls (e.g., a front wall, a rear wall, a left wall and a right wall). However, the packaging container 100 is not limited to a six-walled configuration and may include any other structural configuration known to those skilled in the art and guided by the teachings herein provided.

As illustrated in FIG. 1, in one or more examples, the packaging container 100 is secondary packaging intended for shipping and delivery of the product 120 and, as such, may be referred to as a product-shipping packaging container. In these examples, the product 120 may also include primary packaging 124 that is intended to protect and/or display information about the product 120. As such, the product 120 within the primary packaging 124 may be loaded within the packaging container 100 for shipping and delivery.

In one or more examples, the packaging container 100 is the primary packaging 124. In these examples, the product 120 may be shipped and delivered using the primary packaging 124 as the product-shipping packaging container.

In one or more examples, a first one of the plurality of tags 118 (e.g., first tag 106) is disposed on the packaging container 100 and is encoded with a first one of the plurality of package attributes 142 (FIG. 2). A second one of the plurality of tags 118 (e.g., second tag 108) is disposed on the packaging container 100 and is encoded with a second one of the plurality of package attributes 142. The first tag 106 and the second tag 108 are linked to each other to determine authenticity of the product 120.

In one or more examples, the first tag 106 is disposed at a first location 128 about the packaging container 100. The second tag 108 is disposed at a second location 130 about the packaging container 100. The first location 128 and the second location 130 are different. The first tag 106 and the second tag 108 are affixed to an exterior 140 (e.g., an exterior surface) of the packaging container 100 and are externally accessible such that each one can be read or scanned without opening or otherwise tampering with the packaging container 100, such as while the packaging container 100 is in transit.

In one or more examples, at least one of the tags 118 is tamper resistant. For example, the product packaging 150 may be designed such that at least one of the tags 118 is destroyed, disfigured, or rendered otherwise unreadable when the tag 118 is tampered with. As an example, the first tag 106 is affixed to the exterior 140 of the packaging container 100, such as to one of the walls 102. The second tag 108 is affixed over a closure feature 174 of the packaging container 100.

Generally, the closure feature 174 refers to an element, component or structure of the packaging container 100 that is used to enclose the internal volume 104 of the packaging container 100 and that is openable to access the internal volume 104. As such, the second tag 108 is destroyed, disfigured or rendered otherwise unreadable when the packaging container 100 is opened or the product 120 contained within the packaging container 100 is tampered with.

In one or more examples, the second tag 108 may be printed on a tamper-resistant label that adheres to the exterior 140 of the packaging container 100 and is affixed over the closure feature 174. As such, the second tag 108 is destroyed, disfigured or rendered otherwise unreadable when the label is put in a condition that enables the packaging container 100 to be opened (e.g., removed, cut, torn, etc.).

In one or more examples, the packaging container 100 includes a sealing member 136. The sealing member 136 is affixed to the packaging container 100 over the closure feature 174 and used to seal the packaging container 100 in the closed state. The sealing member 136 may be made of a tamper-resistance material or be otherwise tamper resistant such that the sealing member 136 is destroyed, disfigured or otherwise provides a visual indication of tampering when the packaging container 100 is opened or the product 120 contained within the packaging container 100 is tampered with.

In one or more examples, the second tag 108 is affixed to the sealing member 136. As such, the second tag 108 is destroyed, disfigured or rendered otherwise unreadable when the sealing member 136 is put in a condition that enables the packaging container 100 to be opened (e.g., removed, cut, torn, etc.).

An example of the sealing member 136 is packaging tape 138, or box-sealing tape, that is adhesively attached to the exterior 140 of the packaging container 100 and used to close and seal the packaging container 100. Another example of the sealing member 136 is shrink wrap (not explicitly illustrated) that is wrapped around the packaging container 100 and used to close and seal the packaging container 100. Yet another example of the sealing member 136 is a cable (not explicitly illustrated) that is wrapped around the packaging container 100 and used to close and seal the packaging container 100.

In one example of the product packaging 150, the first tag 106 is a machine-readable optical code (e.g., barcode) printed on one of the walls 102 of the packaging container 100. The second tag 108 is a machine-readable optical code (e.g., barcode) printed on the sealing member 136 (e.g., the packaging tape 138) that is affixed to the packaging container 100 to secure the packaging container 100 in the closed state.

In one or more examples, a third one of the plurality of tags 118 (e.g., third tag 166) is affixed to an interior 172 (e.g., an interior surface) of the packaging container 100 and is encoded with a third one of the plurality of package attributes 142. The first tag 106, the second tag 108 and the third tag 166 are linked to each other to determine the authenticity of the product 120. As such, the packaging container 100 must be opened or tampered with in order to access the third tag 166.

In one or more examples, a fourth one of the plurality of tags 118 (e.g., fourth tag 168) is affixed to the product 120 and is encoded with a fourth one of the plurality of package attributes 142. The first tag 106, the second tag 108 and the fourth tag 168 are linked to each other to determine the authenticity of the product 120. As such, the packaging container 100 must be opened or tampered with in order to access the fourth tag 168. The fourth tag 168 may also be linked to the third tag 166 when the third tag 166 is used.

In one or more examples, a fifth one of the plurality of tags 118 (e.g., fifth tag 170) is affixed to the primary packaging 124 of the product 120 and is encoded with a fifth one of the plurality of package attributes 142. The first tag 106, the second tag 108 and the fifth tag 170 are linked to each other to determine the authenticity of the product 120. As such, the packaging container 100 must be opened or tampered with in order to access the third tag 166. The fifth tag 170 may also be linked to at least one of the third tag 166 and the fourth tag 168 when the third tag 166 and/or the fourth tag 168 are used.

Referring to FIG. 2, which schematically illustrates an example environment 110 for implementing aspects of the systems and methods disclosed herein. In one or more examples, the environment 110 includes a computing device 112 that communicates with a database 158 via a network 152. For example, a central server 162 may run software 164 that maintains the database 158. The environment 110 also includes the product packaging 150. The product packaging 150 includes the packaging container 100 that provides exterior packaging for product 120. The product packaging 150 includes the plurality of tags 118 that are associated with the packaging container 100 and/or the product 120 container within the packaging container 100. Each one of the tags 118 is machine readable and is used to identify the packaging container 100 and/or the product 120 housed within the packaging container 100. For example, each one of the tags 118 may be scanned or read by the computing device 112.

The computing device 112 may run software 164, such as one or more applications, that enables the computing device 112 to communicate with the server 162 via communication pathways (e.g., the network 152). The computing device 112 may collect the information regarding the packaging container 100 and/or the product 120 by scanning or reading the tags 118. The computing device 112 may collect this information via a number of input/output devices 122, including, but not limited to, cameras, Bluetooth readers, radio-frequency identification (RFID) scanners, bar code scanners or wands, touchscreens, other user input devices and the like. In some examples, the computing device 112 may collect or receive information regarding the packaging container 100 and/or the product 120 via the network 152 and a network interface 154.

The database 158 includes a data store of unique codes and information associated with each one of the tags 118. For example, the database 158 may store, for each one of the tags 118, contextual information that characterizes the product packaging 150 and/or an attribute of the packaging container 100 and/or the product 120, referred to herein as the package attributes 142. Examples of the package attributes 142 include, but are not limited to, whether the tag 118 is valid or genuine, whether the tag 118 has been previously scanned or read, the packaging container 100 associated with the tag 118, the product 120 associated with the tag 118, the original producer (e.g., manufacturer, supplier, vendor, etc.) of the product 120, the original producer (e.g., manufacturer, supplier, vendor, etc.) of the packaging container 100, the original packager of the product 120, the location for which the product 120 is loaded in the packaging container 100 associated with the tag 118, the location for which the packaging container 100 associated with the tag 118 is sealed, the market for which the product 120 associated with the tag 118 is intended, the geographic region for which the product 120 associated with the tag 118 is intended to be delivered, the transit path for which the product 120 associated with the tag 118 is intended to travel, the intermediaries (e.g., distributor, common carrier, etc.) for the packaging container 100 associated with the tag 118 through the supply chain, the date of which the product 120 is manufactured, the date of which the product 120 is packaged and/or sealed within the packaging container 100, the date of which the packaging container 100 is shipped, the date of which the packaging container 100 is intended to be delivered, the date of which the packaging container 100 is intended to reach an intermediary, and the like.

In one or more examples, each one of the tags 118 includes, or takes the form of, a label, symbol or other marking that is visually readable and/or machine readable or scannable. The tag 118 contains a code (e.g., encrypted or non-encrypted) that is sent to the server 162 for verification through the database 158. The code is configured or programmed with information or data that identifies at least one of the plurality of package attributes 142. The code may also be configured or programmed with information that identifies which server 162 or database 158 to contact, that identifies the mode of communication to be employed and/or that provides access to the server 162 or database 158. Alternatively, the identity and/or access authorization may be programmed into the software 164 (e.g., application).

In one or more examples, at least one of the tags 118 is a machine-readable optical label that includes a unique identifier, or code, containing information about the packaging container 100 and/or the product 120 to which it is attached. For example, at least one of the tags 118 may include a numerical or visual representation of a code that identifies or that is associated with or one or more of the package attributes 142 of the packaging container 100 and/or the product 120, for example, stored in the database 158.

In one or more examples, at least one of the tags 118 may be a printed code. As an example, at least one of the tags 118 (e.g., first tag 106) may be printed on the exterior 140 of the packaging container 100. As another example, at least one of the tags 118 (e.g., second tag 108) may be printed on a label that is applied (e.g., adhesively affixed) to the exterior 140 of the packaging container 100, such as over the closure feature 174 (FIG. 1). As another example, at least one of the tags 118 (e.g., second tag 108) may be printed on the sealing member 136 (FIG. 1) of the packaging container 100 over the closure feature 174. As an example, at least one of the tags 118 (e.g., third tag 166) may be printed on the interior 172 (FIG. 1) of the packaging container 100. As an example, at least one of the tags 118 (e.g., fourth tag 168) may be printed on the product 120. As another example, at least one of the tags 118 (e.g., fifth tag 170) may be printed on the primary packaging 124 of the product 120.

In one or more examples, at least one of the tags 118 includes, or takes the form, of a barcode. As an example, at least one of the tags 118 is a linear, or one-dimensional, barcode that is made up of lines and spaces of various widths that create specific patterns. As another example, at least one of the tags 118 is a matrix, or two-dimensional, barcode. An example of the matrix barcode is a Quick Response (QR) code that is made up of black squares arranged in a square grid on a white background, which can be read by an imaging device such as a camera. Another example of the matrix barcode is a Digimarc® Barcode (DWCode) that is made up of imperceptible patterns that can be applied to and/or repeated across a packaging material, which can be read by an imaging device such as a camera.

In one or more examples, at least one of the tags 118 includes, or takes the form of, an RFID tag that includes RFID information in addition to or instead of the optically readable tag or code (e.g., barcode). The RFID information may be designed to work with Near Field Communication (NFC) or any other standard RFID tag used in the industry.

It should be appreciated that the examples of the tags 118 depicted in FIG. 1 are for illustrative purposes and are not intended to be limiting. As such, the locations of the tags 118 and the particular type of machine-readable code illustrated in FIG. 1 may vary as guided by the teachings provided herein.

While a single first tag 106 disposed on the exterior 140 of the packaging container 100 and a single second tag 108 disposed on the sealing member 136 are shown by example in FIG. 1, in other examples of the product packaging 150, additional copies of the first tag 106 and/or the second tag 108 may be utilized. As an example, the first tag 106 may be duplicated (e.g., printed or affixed) on two or more of the walls 102 of the packaging container 100. As another example, the second tag 108 may be duplicated or repeated along the length of the sealing member 136. In still other examples, a portion of or an entirety of the surface of the packaging container 100 and/or the sealing member 136 may have an encoded pattern that can be read by an imaging device. For example, the first tag 106 and/or the second tag 108 may be the Digimarc® code printed on the packaging container 100 and/or the package-sealing member 136, respectively.

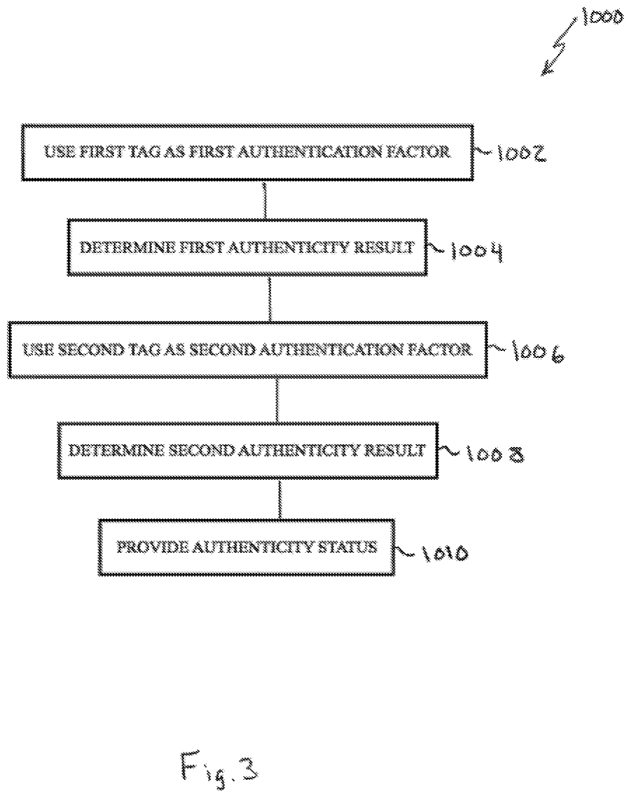

Referring to FIG. 3, which illustrates an example of a method 1000 for authenticating the product 120. Implementations of the method 1000 may be used to package, seal, identify and authenticate the product 120 using the disclosed product packaging 150.

In one or more examples, the method 1000 includes a step of (block 1002) using the first tag 106, applied to the packaging container 100 containing the product 120, as a first authentication factor. The first tag 106 is encoded with the first one of the plurality of package attributes 142. The method 1000 includes a step of (block 1004) determining a first authenticity result for the product 120 based on validation of the first tag 106. The method 1000 includes a step of (block 1006) using the second tag 108, applied to the sealing member 136 affixed over the closure feature 174 of the packaging container 100, as a second authentication factor. The second tag 108 is encoded with the second one of the plurality of package attributes 142. The method 1000 includes a step of (block 1008) determining a second authenticity result for the product 120 based on a valid association of the second tag 108 with the first tag 106. The method 1000 includes a step of (block 1010) providing an authentication status for the product 120 based on each one of the first authenticity result and the second authenticity result.

Referring to FIG. 2, in one or more examples, during an authentication process, the first tag 106 is read or scanned using the computing device 112. An authentication request is transmitted to the server 162. In one or more examples, the first tag 106 is encoded with an authorization to access the database 158 that stores the data representing the plurality of package attributes 142. For example, the first tag 106 may also be encoded with a unique Uniform Resource Locator (URL) that is mapped to a web-based application that provides an interface with the server 162 and the database 158, for example, via an interface module 146. The first one of the package attributes 142 associated with the first tag 106 is compared to the data store and a determination is made whether the code matches the code stored in the database 158. The first authenticity result is transmitted back to the computing device 112 as the authentication status, for example, in the form of a verification of authenticity or an alert, for example, via an authentication module 148. Validation of the first tag 106 provides a first layer of authenticity verification for the product 120.

Upon a first verification of authenticity, the second tag 108 is read or scanned using the computing device 112. An authentication request is transmitted to the server 162. The second one of the package attributes 142 associated with the second tag 108 is compared to the data store and a determination is made whether the code matches the code stored in the database 158 and/or whether the second tag 108 is linked to the first tag 106. The second authenticity result is transmitted back to the computing device 112 as the authentication status, for example, in the form of a verification of authenticity or an alert, for example, via the authentication module 148. A valid association of the second tag 108 with the first tag 106 provides a second layer of authenticity verification for the product 120.

Upon a second verification of authenticity, this process may be successively repeated using additional tags 118 to determine additional authenticity results and to provide additional layers of authenticity verification in a cascading manner. As an example, valid association of the third tag 166 with the first tag 106 and the second tag 108 provides a third authenticity result and a third layer of authenticity verification for the product 120. As another example, a valid association of the fourth tag 168 with the first tag 106, the second tag 108 and/or the third tag 166 provides a fourth authenticity result and a fourth layer of authenticity verification for the product 120. As another example, a valid association of the fifth tag 170 with the first tag 106, the second tag 108, the third tag 166 and/or the fourth tag 168 provides a fifth authenticity result and a fifth layer of authenticity verification for the product 120.

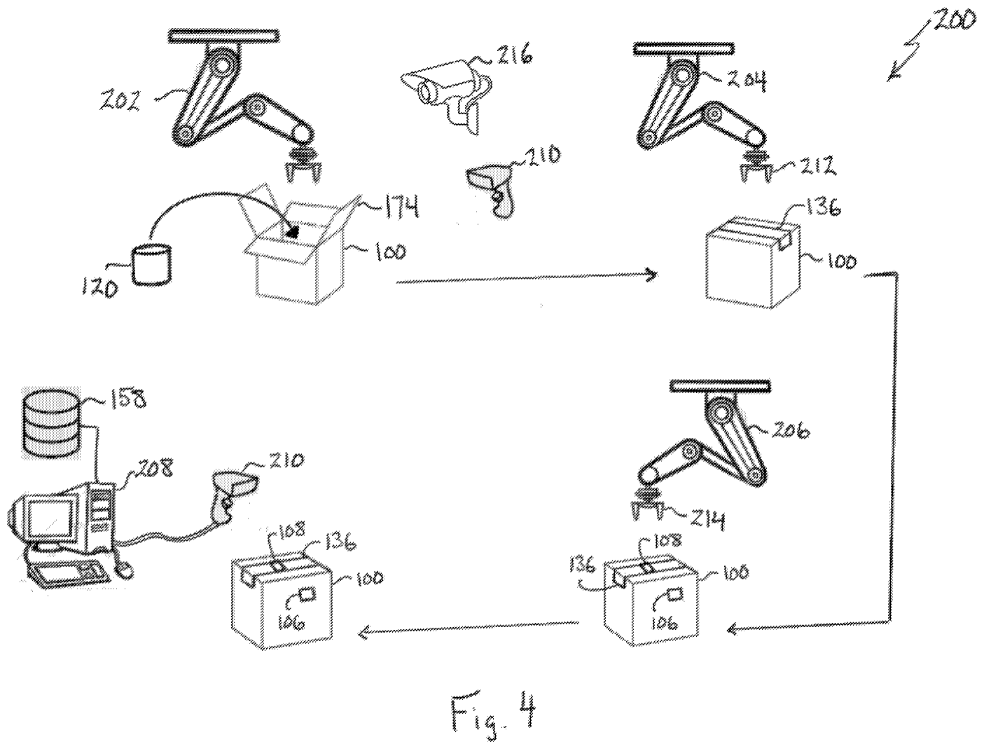

Referring to FIG. 4, which schematically illustrates an example of a system 200 for product authentication. In one or more examples, the system 200 includes the packaging container 100 configured to contain the product 120. The system 200 includes a loading apparatus 202 that is configured to load the product 120 into the packaging container 100. The system 200 includes a sealing apparatus 204 that is configured to seal the packaging container 100 in the closed state. The system 200 includes a tagging apparatus 206 that is configured to apply the tags 118 to the packaging container 100.

The system 200 includes a computing device 208 that is configured, or programmed, to record the tags 118 and link the tags 118 together. In one or more examples, each of the tags 118 is machine-readable and the computing device 208 includes a reader 210 that is configured to read the tags 118. The system 200 includes the database 158 that is configured to store the data representing the plurality of package attributes 142 associated with each one of the tags 118.

In one or more examples, the sealing apparatus 204 is configured to affix the sealing member 136 over the closure feature 174 of the packaging container 100. In one or more examples, the sealing member 136 is packaging tape 138 and the sealing apparatus 204 includes a tape applicator 212.

In one or more examples, the tagging apparatus 206 is configured to affix the first tag 106 to the exterior of the packaging container 100. In one or more examples, the tagging apparatus 206 is configured to affix the second tag 108 to the sealing member 136 (e.g., the packaging tape 138). In one or more examples, the tagging apparatus 206 includes a print head 214. In these examples, each of the tags 118 is an optical code and the reader 219 includes an optical scanner.

In one or more examples, the tagging apparatus 206 is configured to affix the third tag 166 to the interior 172 of the packaging container 100. The computing device 208 is configured to record the third tag 166 and to link the third tag 166 to the first tag 106 and the second tag 108.

In one or more examples, the computing device is configured to record the fourth tag 168 and to link the fourth tag 168 to the first tag 106, the second tag 108 and/or the third tag 166. In one or more examples, the computing device is configured to record the fifth tag 170 and to link the fifth tag 170 to the first tag 106, the second tag 108, the third tag 166 and/or the fourth tag 168.

In one or more examples, the system 200 includes a camera 216 or other vision system that is configured to capture image data representing the product 120 within the packaging container 100. The image data is stored in the database 158 and may be an example of one of the package attributes 142 associated with one of the tags 118.

In one or more examples, the packaging container 100 may be constructed from a blank, for example, manually or using a machine. For example, the system 200 may include an erecting apparatus that is configured to form the packaging container 100 from the blank. The blank includes a series of panels that are connected along a plurality of fold lines. Any one of the fold lines, as well as any other fold lines and/or hinge lines described herein, may include any suitable predefined or preformed line of weakening and/or line of separation known to those skilled in the art and guided by the teachings herein provided, such as a crease, a score, a perforation, or the like. Generally, the fold lines transform the blank into a plurality of separate but integrals panels and flaps. For example, one or more of the panels are hingedly moved (e.g., rotated or folded) about an associated fold line from a flat configuration to a constructed configuration, such that the plurality of panels form the plurality of walls 102 of the packaging container 100.

In one or more examples, the blank and, thus, the packaging container 100 are fabricated from a cardboard material. In other examples, the blank and, thus, the packaging 100 may be fabricated using any suitable material and, therefore, is not limited to a specific type of material. For example, the blank and, thus, the packaging container 100 may be fabricated using at least one of cardboard, plastic, fiberboard, paperboard, foamboard, corrugated paper, corrugated board and any other suitable material known to those skilled in the art and guided by the teachings provided herein. As used herein, a corrugated material generally includes two liner sheets and an inner fluted material that is sandwiched between and is coupled to the liner sheets.

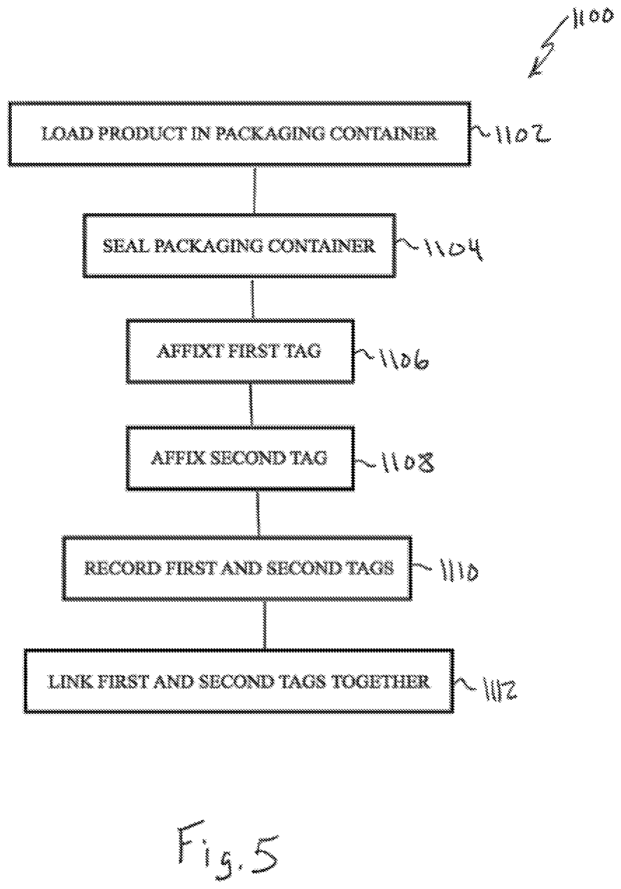

Referring to FIG. 5, which illustrates an example of a method 1100 of packaging the product 120. In one or more examples, the method 1100 is implemented or performed using the system 200 (FIG. 4).

The method 1100 includes a step of (block 1102) loading the product 120 in the packaging container 100. The method 1100 includes a step of (block 1104) sealing the packaging container 100 in the closed state. The method 1100 includes a step of (block 1106) affixing the first tag 106 to the packaging container 100. The method 1100 includes a step of (block 1108) affixing the second tag 108 to the packaging container 100. The method 1100 includes a step of (block 1110) recording the first tag 106 and the second tag 108. The method 1100 incudes a step of (block 1112) linking the first tag 106 and the second tag 108 together.

In one or more examples, the method 1100 includes a step of storing the data representing the first one and the second one of the plurality of package attributes 142 in the database 158.

In one or more examples, the step of (block 1110) recording the first tag 106 and the second tag 108 occurs after the step of (block 1104) sealing the packaging container 100 in the closed state.

In one or more examples, the step of (block 1106) affixing the first tag 106 to the packaging container 100 is performed before the step of loading the product 120 in the packaging container 100. For example, the first tag 106 may be affixed (e.g., printed) on the blank before erecting the packaging container 100.

In one or more examples, the step of (block 1106) affixing the first tag 106 to the packaging container 100 is performed after the step of (block 1104) sealing the packaging container 100 in the closed state.

In one or more examples, the step of (1106) affixing the first tag 106 to the packaging container 100 includes a step of printing an optical code on the exterior 140 of the packaging container 100. In these examples, the step of (1110) recording the first tag 106 includes a step of optically scanning the optical code.

In one or more examples, the step of (1104) sealing the packaging container 100 in the closed state includes a step of affixing the sealing member 136 over the closure feature 174 of the packaging container 100. In one or more examples, the step of (block 1108) affixing the second tag 108 to the packaging container 100 includes a step of printing an optical code on the sealing member 136. In the examples, the step of (block 1110) recording the second tag 108 includes a step of optically scanning the optical code.

In one or more examples, the step of printing the optical code on the sealing member 136 is performed before the step of affixing the sealing member 136 over the closure feature 174 of the packaging container 100. For example, the sealing member 136 (e.g., the packaging tape 138) may include the second tag 108 prior to being affixed to the packaging container 100.

In one or more examples, the step of printing the optical code on the sealing member 136 is performed after the step of affixing the sealing member 136 over the closure feature 174 of the packaging container 100.

In one or more examples, the method 1100 includes a step of affixing the third tag 166 to the packaging container 100. The method 1100 includes a step of recording the third tag 166. The method 1100 includes a step of linking the third tag 166 with the first tag 106 and the second tag 108.

In one or more examples, the method 1100 includes a step of recording the fourth tag 168, affixed to the product 120. The method 1100 includes a step of linking the fourth tag 168 to the first tag 106, the second tag 108 and/or the third tag 166.

In one or more examples, the method 1100 includes a step of recording the fifth tag 170, affixed to the primary packaging 124 of the product 120. The method 1100 includes a step of linking the fifth tag 170 to the first tag 106, the second tag 108, the third tag 166 and/or the fourth tag 168.

In one or more examples, the systems and methods disclosed herein include a code generating process, a code associating process, a code marking process, a code storing process and a code verification process. Accordingly, authentication of the product 120 provided by the product packaging 150, system 200 and methods 1000 and 1100 described herein does not reside in keeping secret the manner of how the unique codes of the tags 118 are generated. Rather, authentication resides in using a combination or aggregate of the package attributes 142 to create a unique signature or fingerprint for the product 120.

As used herein, a computing device (e.g., computing device 112 and/or computing device 208) may generally be any computing device that implements aspects of the present disclosure as described herein. In one or more examples, While the computing device may be a mobile computing device. Examples of a mobile computing device include, but are not limited to, smartphones, tablet computers, laptops, personal computers, wearable computing devices, personal digital assistants (PDA)s, hybrid PDA/mobile phones, integrated components for inclusion in computing devices, appliances, electronic devices for inclusion in machinery and the like.

The computing device includes various components and modules for implementing aspects of the present disclosure. One skilled in the art will understand the computing device may contain more or fewer components and modules than those illustrated, and further that the components and modules may be combined or divided in various embodiments. Generally, the computing device includes a processor 156, a network interface 154, and a number of input/output devices 122, all of which may communicate with one another by way of a communication bus. The network interface 154 may provide connectivity to one or more networks (such as the network 152) and, as a result, may enable the computing device to send and receive information and instructions to and from other computing systems or services, such as the server 162 and the database 158.

The processor 156 may also communicate with and/or from a memory 160. The memory 160 may contain computer program instructions (grouped as modules or components in some examples) that the processor 156 may execute in order to implement one or more examples. The memory 160 generally includes RAM, ROM, and/or other persistent, auxiliary, or non-transitory computer-readable media. The memory 160 may store an operating system 144 that provides computer program instructions for use by the processor 156 in the general administration and operation of the computing device. The memory 160 may further store specific computer-executable instructions and other information (which may be referred to herein as “modules”) for implementing aspects of the present disclosure.

As used here, “affixing” includes, but is not limited, to physical attaching the tag, printing the tag, inserting the tag, building the tag or any other way of ensuring that the tag is not separable without tampering with the product or its packaging.

It is to be understood that not necessarily all objects or advantages may be achieved in accordance with any particular example described herein. Thus, for example, those skilled in the art will recognize that certain examples may be configured to operate in a manner that achieves or optimizes one advantage or group of advantages as taught herein without necessarily achieving other objects or advantages as may be taught or suggested herein.

All of the processes described herein may be embodied in, and fully automated via, software code modules, including one or more specific computer-executable instructions, that are executed by a computing system. The computing system may include one or more computers or processors. The code modules may be stored in any type of non-transitory computer-readable medium or other computer storage device. Some or all the methods may be embodied in specialized computer hardware.

Many other variations than those described herein will be apparent from the present disclosure. For example, depending on the example, certain operations, acts, events or functions of any of the algorithms or processes described herein may be performed in a different sequence, can be added, merged, or left out altogether (e.g., not all described operations are necessary for the practice of the process). Moreover, in certain examples, operations may be performed concurrently (e.g., through multi-threaded processing, interrupt processing, or multiple processors or processor cores or on other parallel architectures), rather than sequentially. In addition, different tasks or operations may be performed by different machines and/or computing systems that can function together.

It should be appreciated that, when used to modify a structure, an element, an item, a component or a feature described herein, the terms “front,” “rear,” “bottom,” “top,” “left,” “right,” “side,” “end,” as well as similar terms or other forms of such terms, are relative and refer to an example of a spatial relationship between structures, elements, items, components or features. As such, examples of the packaging container 100 and the blank 126, described herein and illustrated in the figures, are not intended to be limited by the specific relative terms used to describe any structure, element, item, component or feature of the packaging container 100 or the blank 126.

Conditional language such as, among others, “can” or “may,” unless specifically stated otherwise, are otherwise understood within the context as used in general to convey that certain examples include, while other examples do not include, certain features, elements and/or steps. Thus, such conditional language is not generally intended to imply that features, elements and/or steps are in any way required for one or more examples or that one or more examples necessarily include logic for deciding, with or without user input or prompting, whether these features, elements and/or steps are included or are to be performed in any particular example.

Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

Unless otherwise indicated, the terms “first,” “second,” “third,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, the phrase “at least one of,” when used with a list of items, means different combinations of one or more of the listed items may be used and only one of each item in the list may be needed. For example, “at least one of item A, item B, and item C” may include, without limitation, item A or item A and item B. This example also may include item A, item B, and item C, or item B and item C. In other examples, “at least one of” may be, for example, without limitation, two of item A, one of item B, and ten of item C; four of item B and seven of item C; and other suitable combinations.

Those skilled in the art will appreciate that not all elements described and illustrated in FIGS. 1-5 need be included in every example and not all elements described herein are necessarily depicted in each illustrative example. Unless otherwise explicitly stated, the schematic illustrations of the examples depicted in FIGS. 1-5 are not meant to imply structural limitations with respect to the illustrative example. Rather, although one illustrative structure is indicated, it is to be understood that the structure may be modified when appropriate. Additionally, modifications, additions and/or omissions may be made to the illustrated structure.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Further, references throughout the present specification to features, advantages, or similar language used herein do not imply that all of the features and advantages that may be realized with the examples disclosed herein should be, or are in, any single example. Rather, language referring to the features and advantages is understood to mean that a specific feature, advantage, or characteristic described in connection with an example is included in at least one example. Thus, discussion of features, advantages, and similar language used throughout the present disclosure may, but do not necessarily, refer to the same example.

The described features, advantages, and characteristics of one example may be combined in any suitable manner in one or more other examples. One skilled in the relevant art will recognize that the examples described herein may be practiced without one or more of the specific features or advantages of a particular example. In other instances, additional features and advantages may be recognized in certain examples that may not be present in all examples. Furthermore, although various examples of the packaging 150, system 200 and methods 1000 and 1100 have been shown and described, modifications may occur to those skilled in the art upon reading the specification. The present application includes such modifications and is limited only by the scope of the claims.

1. Product packaging comprising:
a packaging container configured to contain product;
a first tag disposed on the packaging container and encoded with a first one of a plurality of package attributes; and
a second tag disposed on the packaging container and encoded with a second one of the plurality of package attributes,
wherein authenticity of the first tag is configured to be validated independent of the second tag and authenticity of the second tag is configured to be validated independent of the first tag.

2. The product packaging of claim 1 wherein the first tag is further encoded with an authorization to access a database that stores data representing the first one of the plurality of package attributes.

3. The product packaging of claim 2 wherein the first tag is further encoded with a unique Uniform Resource Locator (URL) mapped to a web-based application that provides an interface with the database.

4. The product packaging of claim 2 wherein the second tag is further encoded with an authorization to access a second database that stores data representing the second one of the plurality of package attributes.

5. The product packaging of claim 4 wherein the second database becomes accessible after validating the authenticity of the first tag WO.

6. The product packaging of claim 1 wherein each of the first tag and the second tag is machine-readable.

7. The product packaging of claim 1 wherein each of the first tag and the second tag is a machine-readable optical code.

8. The product packaging of claim 1 wherein: the first tag is disposed at a first location about the packaging container;
the second tag is disposed at a second location about the packaging container; and
the first location and the second location are different.

9. The product packaging of claim 8 wherein the first tag and the second tag are affixed to an exterior of the packaging container and are each externally accessible to be read or scanned without opening or otherwise tampering with the packaging container.

10. The product packaging of claim 9 wherein at least one of the first tag and the second tag is tamper resistant such that the tag is at least one of destroyed, disfigured, or rendered unreadable when tampered with.

11. The product packaging of claim 10 wherein:
the first tag is affixed to an exterior of the packaging container; and
the second tag is tamper resistant and is affixed over a closure feature of the packaging container.

12. The product packaging of claim 11 wherein the second tag is printed on a tamper-resistant label that adheres to the exterior of the packing container and is affixed over the closure feature.

13. The product packaging of claim 11 further comprising a sealing member affixed over the closure feature of the packaging container, wherein the second tag is tamper resistant and is affixed to the sealing member.

14. The product packaging of claim 13 wherein the sealing member comprises packaging tape.

15. The product packaging of claim 1 wherein:
validation of authenticity of the first tag and the second tag indicates at least one of the packaging container or the product contained within the packaging container has not been tampered with.

16. A method for authenticating a product, the method comprising:
using a first tag, applied to a packaging container containing the product, as a first authentication factor, wherein the first tag is encoded with a first one of a plurality of package attributes;
determining a first authenticity result for the product based on validation of the first tag;
using a second tag, applied to a sealing member affixed over a closure feature of the packaging container, as a second authentication factor, wherein the second tag is encoded with a second one of a plurality of package attributes and is tamper-resistant; and
determining a second authenticity result for the product based on validation of the second tag.

17. The method of claim 16 further comprising providing an authentication status for the product based on each of the first authenticity result and the second authenticity result.

18. The method of claim 16 wherein each of the first tag and the second tag is machine-readable.

19. The method of claim 18 wherein the tamper-resistant second tag cannot be validated if destroyed, disfigured, or rendered unreadable from tampering.

20-22. (canceled)

23. A system for product authentication, the system comprising:
a packaging container configured to contain product;
a loading apparatus configured to load the product into the packaging container;
a sealing apparatus configured to seal the packaging container in a closed state;
a tagging apparatus configured to apply a first tag encoded with a first one of a plurality of package attributes and a second tag encoded with a second one of a plurality of package attributes, to the packaging container; and
a computing device configured to record the first tag and the second tag.

24-30. (canceled)
